(19) United States
(12) Patent Application Publication
(10) Pub. No.: US 2013/0017512 A1
(43) Pub. Date: Jan. 17, 2013

(54) DENTAL IMPLANT SYSTEM FOR PROMOTING OSSEOINTEGRATION

(71) Applicant: Yu-Hong Tzeng, Taipei City (TW)

(72) Inventor: Yu-Hong Tzeng, Taipei City (TW)

(21) Appl. No.: 13/180,432

(22) Filed: Jul. 11, 2011

(51) Int. Cl. A61C 8/00

(52) U.S. Cl. 433/174

(57) ABSTRACT

A dental implant system for promoting osseointegration comprises an implant in cylindrical shape having a thread division at bottom, which can be screwed in the oral alveolar bone of a patient at the location of the implant: where the implant has a neck part on top being located at the same level as the cortical bone of the alveolar bone, as the implant is screwed in the alveolar bone; characterized in that: the surface of the neck part has uneven lines, of which the gapes keep the bone blood on the neck part surface and therefore promote cortical bone growing.

### FIELD OF THE INVENTION

The present invention relates to a dental implant system for promoting osseointegration, particularly to a dental implant system applied for an invasive type of fast implantation.

### BACKGROUND OF THE INVENTION

In conventional implant surgery, a dental implant (or an artificial tooth root) will be embedded in the oral alveolar bone of the patient, then a prosthetic tooth will be positioned in gums. This process has two phases: firstly drilling in an alveolar bone, secondly screwing an implant in the hole of alveolar bone. In an early period of screwing, when the alveolar bone still has no osseointegration with the dental implant, a stress—free period is required to avoid a micro—motion which can cause loosening of new bone tissue. So after the dental implantation, the gum usually will be temporarily sutured. It is waited until osseointegration is finished, then the second phase is performed: opening the gum, fixing an abutment in the dental implant, finally manufacturing a prosthetic tooth over the abutment.

Titanium has a high biocompatibility which avoids generating exclusion or inflammation in human body. Since titanium has a characteristic of easily growing for bone tissue and combining with it, titanium is widely applied for manufacturing dental implants. Thus combining between implant and alveolar bone depends not only on mechanical force, but also biological connecting.

A conventional implant is of cylindrical shape and has a thread on an outer surface for screwing in the alveolar bone. The implant has a mounting hole on top for an abutment to plug in and combine with.

For improving the osseointegration between implant and alveolar bone and avoiding micro-motion, it is advantageous to alter the overall structure of the implant with surface treatment.

Usually the main body of the implant is buried in the inner sponge bone tissue after implantation. Only the surface of the neck part, which is connected with the abutment along a section of about 2 mm, contacts the outward cortical bone of the alveolar bone. Since hardness and strength of the cortical bone are higher then that of sponge bone, the stability of the neck part and cortical bone combining is decisive for the stability of implantion.

Therefore, a conventional implant usually comprises a thread on the neck part, as, for example, disclosed in Taiwan Patent nos. M315571 and M344871, and U.S. patent request Ser. No. 11/074,051 (EXTERNALLY-THREADED ONE-PIECE ENDOSSEOUS DENTAL IMPLANT WITH ANGLED ABUTMENT).

Though the conventional implant comprising thread on the neck part exerts a higher clasping force between the implant and cortical bone, it is not effective for reducing the osseointegration time. A long while is required for completion of osseointegration after implantation So conventional implants are ineffective for reducing failure rates of operations.

### SUMMARY OF THE INVENTION

The main object of the present invention is to provide a dental implant system for promoting osseointegration which improves combining stability between an implant and the alveolar bone, while furthering growth of the cortical bone growing, so that more complete osseointegration is achieved.

For achieving above objects, the present invention comprises a thread division embossed on the neck part of an implant, so that the neck part and cortical bone of the alveolar bone are stably engaged with each other. Gaps of the thread offer room for reserving bone blood, so that cortical bone growing is fruthered and the required time for osseointegration is reduced, resulting in more effective osseointegration.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a side elevation of the implant of the present invention.

FIG. 2 is a perspective view of the present invention.

FIG. 3 is a cross-sectional side view of the present invention in the first embodiment by implantation: an implant being implanted in the alveolar bone of patient's mouth and a prosthetic tooth being embedded on the implant.

FIG. 4 is a side elevation of the implant in the second embodiment of the present invention.

### DESCRIPTION OF THE PREFERRED EMBODIMENTS

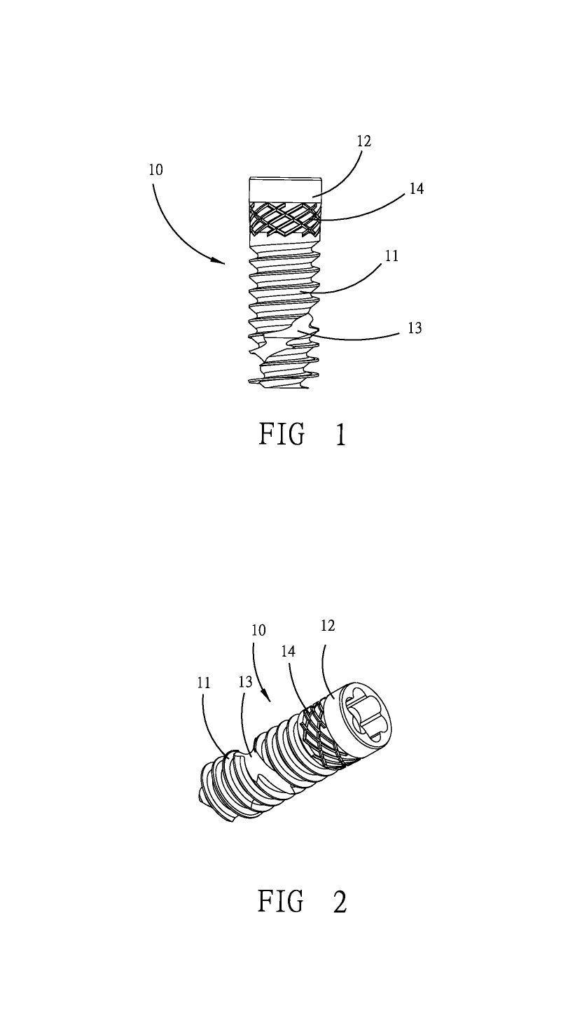

FIGS. 1-3 show the first embodiment of the dental implant system for promoting osseointegration of the present invention, wherein an implant 10 is a cylinder made of metal material. Defined by the implanting direction into an alveolar bone 40, the implant 10 has an upper part and a bottom part. The bottom part in cylindrical shape has on an outward surface a thread division 11, while the upper part has a neck part 12 connected with an abutment 20. By the abutment 20, the prosthetic tooth is mounted over the implant.

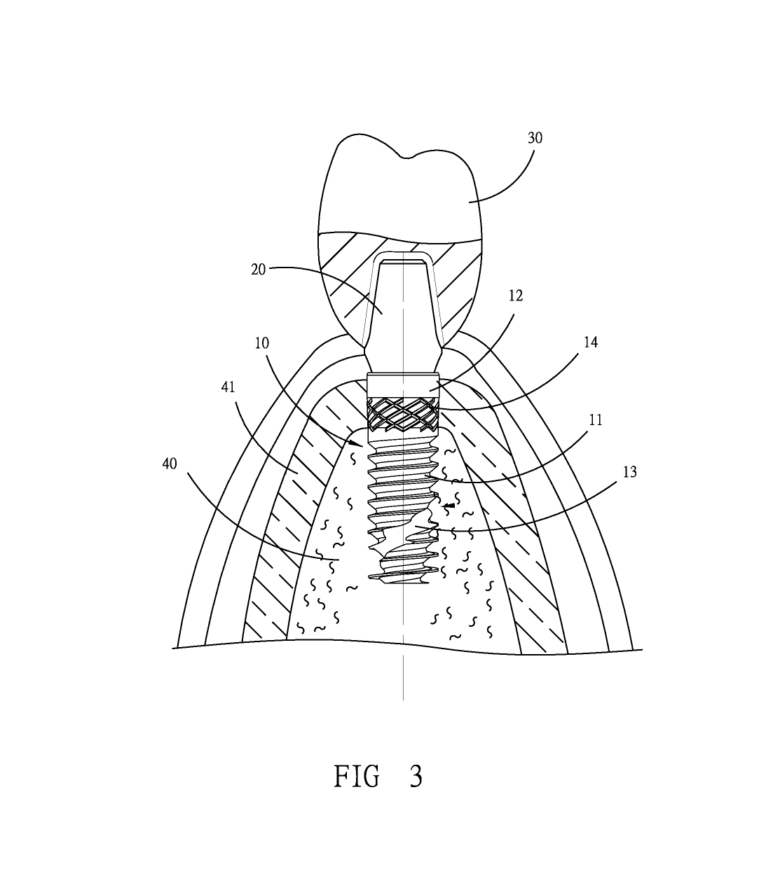

As shown in FIG. 2, the thread division 11 of the implant 10 is a self-tapping thread. The thread division 11 allows for biting with bone tissue and accommodating bone scraps by screwing in the oral alveolar bone. For improving bloody affinity as well as sealing ability after the osseointegration, the surface of thread can be handled either by blasting, chemistry etching or plasma treatment.

As shown in FIG. 3, the implant 10 in the first embodiment of the present invention is a multistage design, that is, the implant 10 and the abutment 20 for mounting the prosthetic tooth 30 are separated objects. As shown in FIG. 3, implant surgery is performed firstly by drilling on where the denture is located, then screwing the implant 10 in the hole of the oral alveolar bone 40.

As the implant 10 is embedded in the alveolar bone 40, the thread division 11 of the implant 10 at bottom is screwed in the tissue of the alveolar bone 40, while the neck part 12 of the implant 10 on top comes into contact with the cortical bone 41 of the alveolar bone 40. During normal implant surgery, after the implantation gums is sutured, and the osseointegration is performed. So the implant 10 extends beyond the gums, and then the abutment 20 will be jointed on top of the neck part 12. Thereafter the formed prosthetic tooth 30 will be mounted over the abutment 20.

The main characteristic of the present invention is the surface of the neck part 12 of the implant 10 comprising a pattern of recesses and bulges 14, formed by roll processing. Thereby, an increased contact area is available between the neck part 12 and the cortical bone 41 of the alveolar bone 40. Hence distribution of stress is changed, and the bonding strength between cortical bone 41 and neck part 12 is improved.

Besides, the neck part 12 with pattern of recesses and bulges 14 is significant for keeping more blood on gapes between neck part 12 and the cortical bone 41, being helpful for growth rate of the cortical bone 41 as well as a fast and sealed osseointegration.

The implant 10 comprising pattern of recesses and bulges 14 of the first embodiment of the present invention is treated by roll processing on the surface of the neck part 12, wherein the pattern of recesses and bulges 14 has a line spacing of about 0.1˜0.3 mm.

Manufacturing of the pattern of recesses and bulges 14 is not restricted to determined treatments. Various processes, like rolling, embossing, plastic deformation or cutting are available. Furthermore, there are no restrictions as to shape, line spacing and size of the pattern of recesses and bulges 14, which are variable according to requirements.

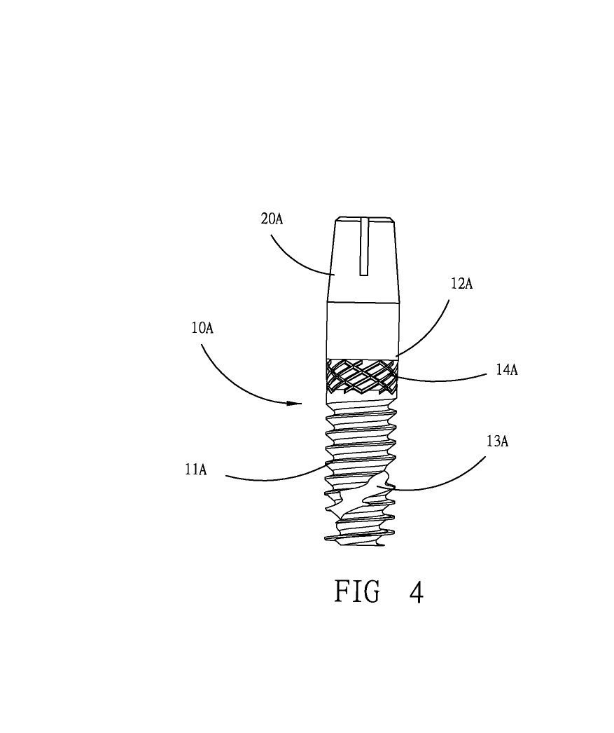

As shown in FIG. 4, the implant 10A in another embodiment of the present invention is designed as one piece, wherein the integrated implant 10A comprises a thread division 11A at bottom having at least a groove 13A in front and a neck part 12A on top. The neck part 12A is jointed with an integrated abutment 20A. The neck part 12A on an outward surface, as in the first embodiment, comprises a pattern of recesses and bulges 14A, which furthers a fast and sealed osseointegration after implantation.

The present invention allows improved stability of implant 10, 10A screwed in the oral alveolar bone 40 and furthermore a fast and sealed osseointegration between the cortical bone 41 and the neck parts 12, 12A. While preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A dental implant system for promoting osseointegration, which promotes the osseointegration between the cortical bone or the oral alveolar bone and the implant; comprising an implant in cylindrical shape,
having a thread division at bottom, which can be screwed in the said alveolar bone;
having a neck part on top
which is located at the same level as the cortical hone of the oral alveolar bone of a patient, as said implant to be screwed in the alveolar hone;
which allows being jointed with an abutment on top and thereafter mounted with a prosthetic tooth over the said abutment;
characterized in that
the said neck part surface is formed in a pattern of interconnected recesses and bulges, to improve the biting stability between the said neck part and the cortical bone of alveolar bone as well as promote a fast and sealed osseointegration.

2. The dental implant system for promoting osseointegration of claim 1, wherein said thread division possesses at least one groove.

3. The dental implant system for promoting osseointegration of claim 2, wherein said abutment and said neck part of the implant are separated objects.

4. The dental implant system for promoting osseointegration of claim 2, wherein said abutment is in one piece jointed on top of said neck part of the implant.

5. The dental implant system for promoting osseointegration of claim 2, wherein said pattern of recesses and bulges is formed through roll processing on the surface of said neck part.

6. The dental implant system for promoting osseointegration of claim 5, wherein said abutment and said neck part of the implant are separated objects.

7. The dental implant system for promoting osseointegration of claim 5, wherein said abutment is jointed in one piece on top of said neck part of the implant.
